(19) United States
(12) Patent Application Publication
(10) Pub. No.: US 2024/0015752 A1
(43) Pub. Date: Jan. 11, 2024

(54) UPLINK CONTROL INFORMATION COOPERATION

(71) Applicant: QUALCOMM Incorporated, San Diego, CA (US)

(72) Inventors: Fang YUAN, Beijing (CN); Wooseok NAM, San Diego, CA (US); Aleksandar DAMNJANOVIC, Del Mar, CA (US); Tao LUO, San Diego, CA (US); Xiaoxia ZHANG, San Diego, CA (US)

(21) Appl. No.: 18/252,678

(22) PCT Filed: Jan. 28, 2021
(86) PCT No.: PCT/CN2021/074062

§ 371 Date: May 11, 2023

(51) Int. Cl. H04W 72/21; H04L 1/1812

(52) U.S. Cl. CPC H04W 72/21; H04L 1/1812

(57) ABSTRACT

Various aspects of the present disclosure generally relate to wireless communication. In some aspects, a user equipment (UE) may receive, from a base station, an indication of a configuration for transmission of uplink control information (UCI) associated with a first antenna group of the UE. The UE may provide, to a second antenna group, the UCI associated with the first antenna group of the UE for transmission to the base station. Numerous other aspects are described.

### FIELD OF THE DISCLOSURE

Aspects of the present disclosure generally relate to wireless communication and to techniques and apparatuses for uplink control information cooperation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a base station, an indication of a configuration for transmission of uplink control information (UCI) associated with a first antenna group of the UE; and providing, to a second antenna group, the UCI associated with the first antenna group of the UE for transmission to the base station.

In some aspects, a method performed by a cooperative UE includes receiving, from a UE, UCI associated with the UE; and transmitting, to a base station, the UCI associated with the UE.

In some aspects, a method performed by a base station includes transmitting, to a first antenna group of a UE, an indication of a configuration for transmission of UCI associated with a first antenna group of the UE; and receiving, via a second antenna group, the UCI associated with the first antenna group.

In some aspects, a UE for wireless communication includes a memory; and one or more processors operatively coupled to the memory, the memory and the one or more processors configured to: receive, from a base station, an indication of a configuration for transmission of UCI associated with a first antenna group of the UE; and provide, to a second antenna group, the UCI associated with the first antenna group of the UE for transmission to the base station.

In some aspects, a cooperative UE for wireless communication includes a memory; and one or more processors operatively coupled to the memory, the memory and the one or more processors configured to: receive, from a UE, UCI associated with the UE; and transmit, to a base station, the UCI associated with the UE.

In some aspects, a base station for wireless communication includes a memory; and one or more processors operatively coupled to the memory, the memory and the one or more processors configured to: transmit, to a first antenna group of a UE, an indication of a configuration for transmission of UCI associated with a first antenna group of the UE; and receive, via a second antenna group, the UCI associated with the first antenna group.

In some aspects, a non-transitory computer-readable medium storing a set of instructions for wireless communication includes one or more instructions that, when executed by one or more processors of a UE, cause the UE to: receive, from a base station, an indication of a configuration for transmission of UCI associated with a first antenna group of the UE; and provide, to a second antenna group, the UCI associated with the first antenna group of the UE for transmission to the base station.

In some aspects, a non-transitory computer-readable medium storing a set of instructions for wireless communication includes one or more instructions that, when executed by one or more processors of a cooperative UE, cause the UE to: receive, from a UE, UCI associated with the UE; and transmit, to a base station, the UCI associated with the UE.

In some aspects, a non-transitory computer-readable medium storing a set of instructions for wireless communication includes one or more instructions that, when executed by one or more processors of a base station, cause the base station to: transmit, to a first antenna group of a UE, an indication of a configuration for transmission of UCI associated with a first antenna group of the UE; and receive, via a second antenna group, the UCI associated with the first antenna group.

In some aspects, an apparatus for wireless communication includes means for receiving, from a base station, an indication of a configuration for transmission of UCI associated with a first antenna group of the apparatus; and means for providing, to a second antenna group, the UCI associated with the first antenna group of the apparatus for transmission to the base station.

In some aspects, an apparatus for wireless communication includes means for receiving, from a UE, UCI associated with the UE; and means for transmitting, to a base station, the UCI associated with the UE.

In some aspects, an apparatus for wireless communication includes means for transmitting, to a first antenna group of a UE, an indication of a configuration for transmission of UCI associated with a first antenna group of the UE; and means for receiving, via a second antenna group, the UCI associated with the first antenna group.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIGS. 3-6 are diagrams illustrating examples associated with uplink control information cooperation, in accordance with the present disclosure.

FIGS. 7-9 are diagrams illustrating example processes associated with uplink control information cooperation, in accordance with the present disclosure.

FIGS. 10-12 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

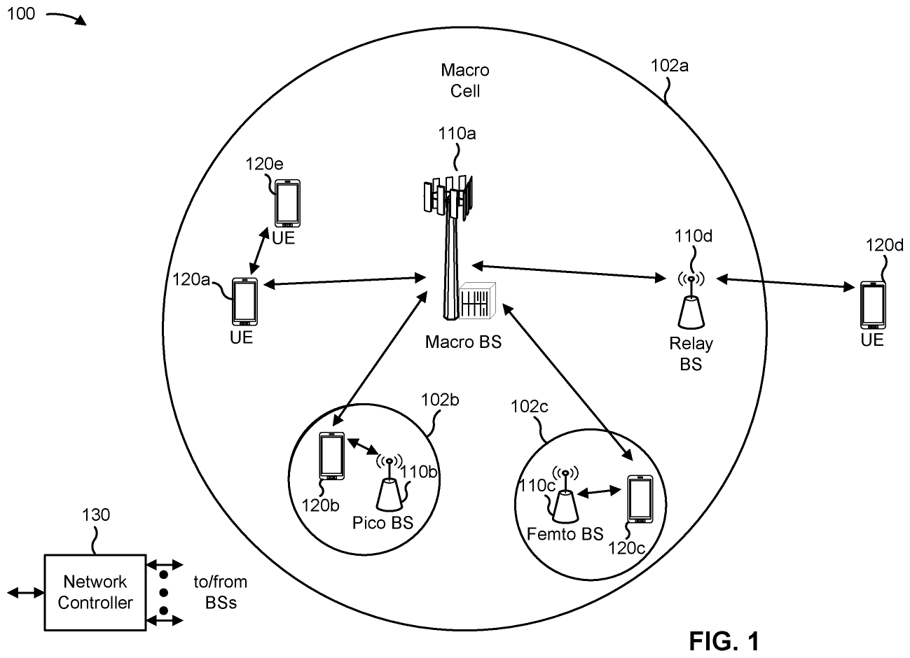

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each ULE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

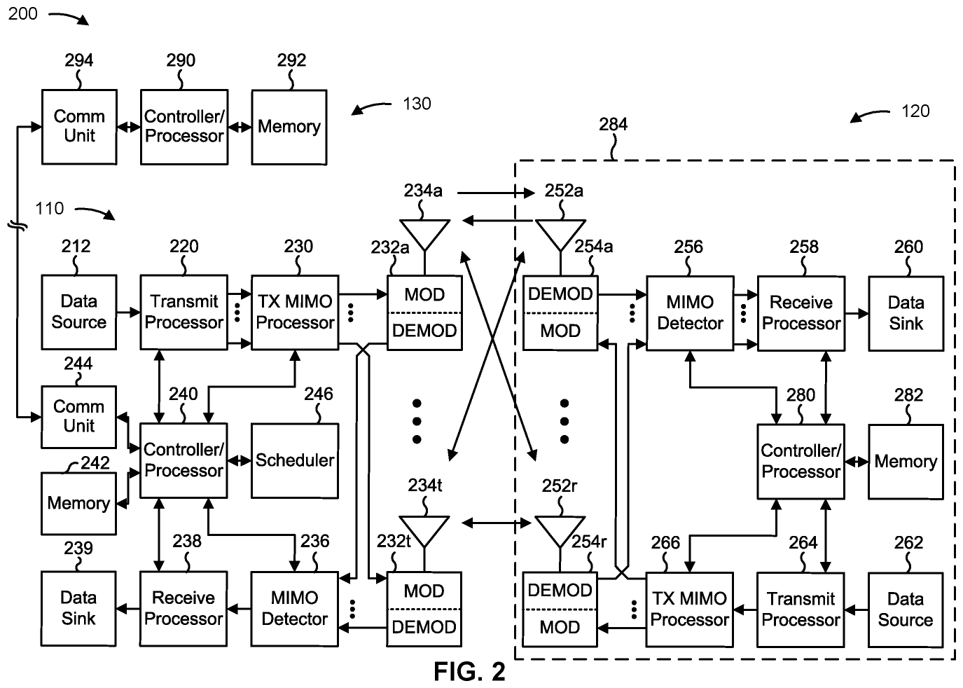

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. In terms of radio frequency functionality, an antenna panel, an antenna group, a set of antenna elements, and/or an antenna array may include a collection of one or more antenna ports that is able to generate an analog beam (e.g., a single analog beam). Different antenna groups (or antenna panels, set of antenna elements, antenna array) can be associated with a same, or a different, number of antenna ports, number of beams, and Effective Isotropic Radiated Power (EIRP). An antenna panel, an antenna group, a set of antenna elements, and/or an antenna array may include one or more antenna elements coupled to one or more transmission and/or reception components, such as one or more components of FIG. 2.

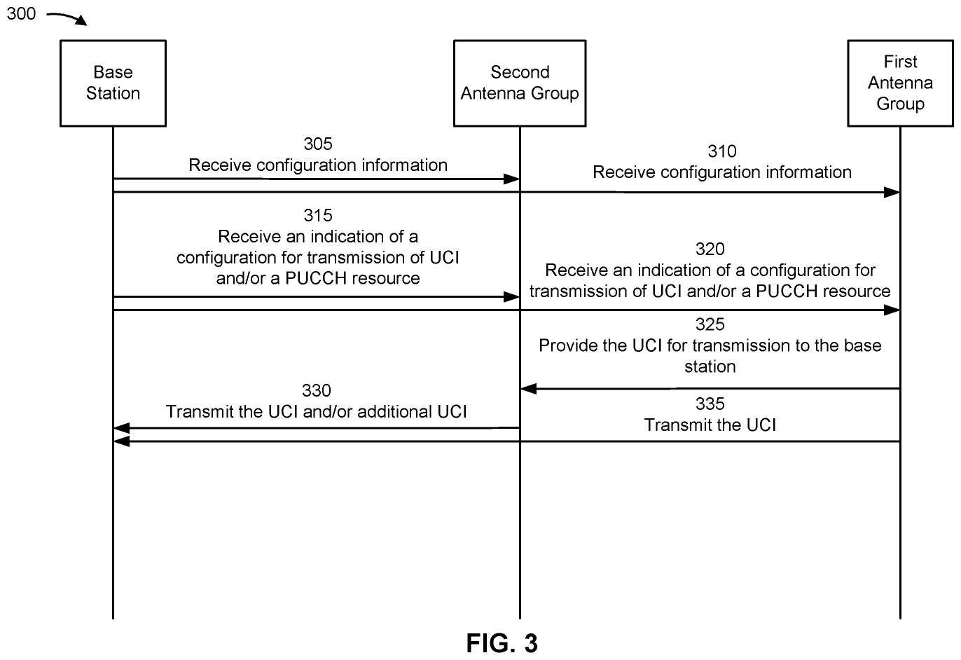

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-9.

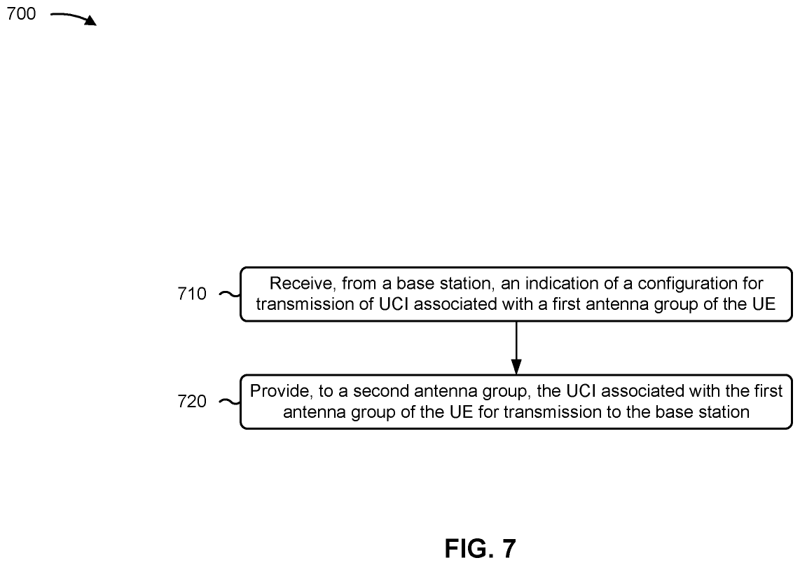

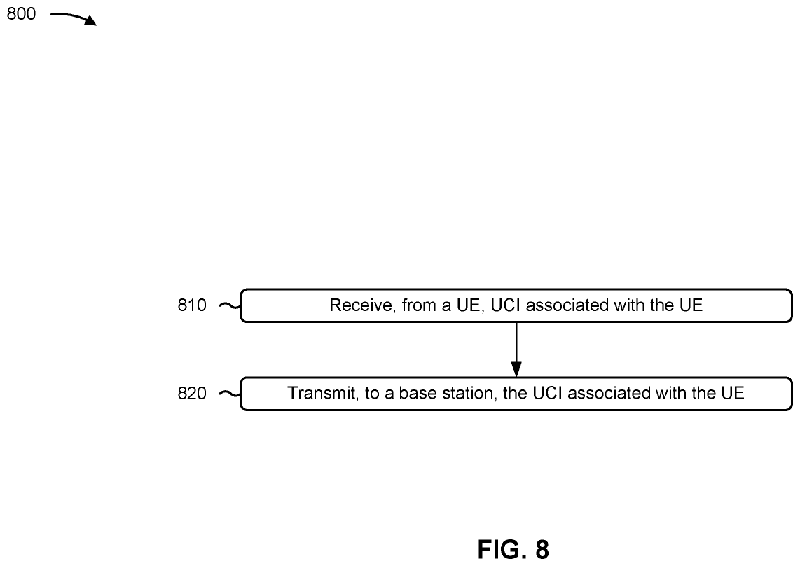

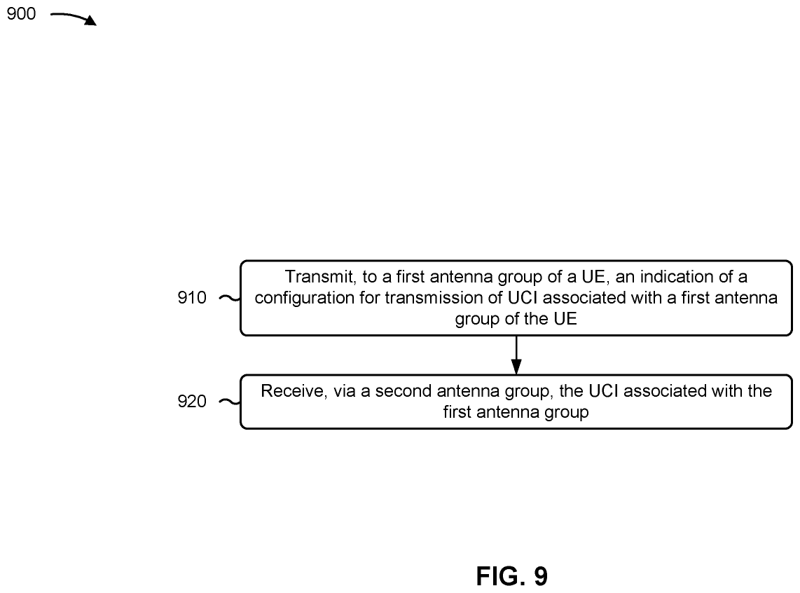

Controller/processor 240 of base station 110, controller/processor 280 of UE 120, and/or any other component(s) of FIG. 2 may perform one or more techniques associated with uplink control information cooperation, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, process 900 of FIG. 9, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, and/or other processes as described herein. In some aspects, executing instructions may include running the instructions, converting the instructions, compiling the instructions, and/or interpreting the instructions, among other examples.

In some aspects, the UE includes means for receiving, from a base station, an indication of a configuration for transmission of uplink control information (UCI) associated with a first antenna group of the UE; or means for providing, to a second antenna group, the UCI associated with the first antenna group of the UE for transmission to the base station. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for transmitting, via the second antenna group of the UE, the UCI associated with the first antenna group.

In some aspects, the UE includes means for transmitting the UCI associated with the first antenna group via a physical uplink control channel (PUCCH) resource configured for the first antenna group, or means for transmitting the UCI associated with the first antenna group via a PUCCH resource configured for the second antenna group.

In some aspects, the UE includes means for transmitting, via the second antenna group, a PUCCH communication that includes the UCI associated with the first antenna group of the UE and additional UCI associated with the second antenna group of the UE.

In some aspects, the UE includes means for transmitting the PUCCH communication including a first UCI group associated with the first antenna group and a second UCI group associated with the second antenna group, or means for transmitting the PUCCH communication including a single UCI group based at least in part on a single hybrid automatic repeat request (HARQ) codebook configured for the first antenna group and the second antenna group.

In some aspects, the UE includes means for transmitting, to the cooperative UE, the UCI associated with the first antenna group for transmission to the base station.

In some aspects, the UE includes means for transmitting a repetition of the UCI via the first antenna group of the UE.

In some aspects, the cooperative UE includes means for receiving, from a UE, UCI associated with the UE; or means for transmitting, to a base station, the UCI associated with the UE. The means for the cooperative UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the cooperative UE includes means for transmitting a PUCCH communication that includes the UCI associated with the UE and additional UCI associated with the cooperative UE.

In some aspects, the cooperative UE includes means for transmitting the UCI associated with the UE via a PUCCH resource configured for the UE, or means for transmitting the UCI associated with the UE via a PUCCH resource configured for the cooperative UE.

In some aspects, the cooperative UE includes means for receiving a configuration of a PUCCH resource configured for the cooperative UE, wherein the configuration of the PUCCH resource configured for the cooperative UE includes one or more of an indication of an identification of the cooperative UE, an indication of a resource timing that is based at least in part on a numerology of the cooperative UE, or an indication of a secondary PUCCH cell group as a supplementary PUCCH for transmission of the UCI associated with the UE.

In some aspects, the base station includes means for transmitting, to a first antenna group of a UE, an indication of a configuration for transmission of UCI associated with a first antenna group of the UE; or means for receiving, via a second antenna group, the UCI associated with the first antenna group. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

In some aspects, the base station includes means for receiving the UCI associated with the first antenna group via a PUCCH resource configured for the first antenna group, or means for receiving the UCI associated with the first antenna group via a PUCCH resource configured for the second antenna group.

In some aspects, the base station includes means for receiving, via the second antenna group, a PUCCH communication that includes the UCI associated with the first antenna group and additional UCI associated with the second antenna group.

In some aspects, the base station includes means for receiving a PUCCH communication including a first UCI group associated with the first antenna group and a second UCI group associated with the second antenna group, or means for receiving the PUCCH communication including a single UCI group based at least in part on a single HARQ codebook configured for the first antenna group and the second antenna group.

In some aspects, the base station includes means for receiving the UCI associated with the first antenna group via a PUCCH format 3 communication or a PUCCH format 4 communication.

In some aspects, the base station includes means for receiving a repetition of the UCI via the first antenna group of the UE.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

A UE may be configured to transmit UCI based at least in part on receiving a data communication (e.g., via a physical downlink shared channel (PDSCH)). For example, the UE may be configured to transmit HARQ feedback (e.g., acknowledgement (ACK) and/or negative acknowledgement (NACK)) associated with the data communication. Transmission of the UCI may consume power, communication, and/or network resources. Additionally, the UE may require capabilities and/or components to transmit the UCI to an associated base station.

In some aspects described herein, a UE may receive an indication of a configuration for transmission of UCI associated with a first antenna group of the UE. The UE may provide the UCI to a second antenna group for transmission to the base station. In some aspects, the second antenna group may include a second antenna group of the UE. In some aspects, the second antenna group may include an antenna group of a cooperative UE (i.e., another UE). In some aspects, the second antenna group may transmit the UCI associated with the first antenna group. In some aspects, the second antenna group may transmit additional UCI (e.g., associated with the second antenna group) with the UCI associated with the first antenna group. In some aspects, the second antenna group may transmit the UCI using a PUCCH resource configured for the first antenna group. In some aspects, the second antenna group may transmit the UCI using a PUCCH resource configured for the second antenna group.

Based at least in part on the first antenna group providing the UCI to the second antenna group and the second antenna group transmitting the UCI with additional UCI, the UE and/or the cooperative UE may conserve power, communication, and/or network resources that may have otherwise been used to transmit the UCI separately from the additional UCI. Based at least in part on the first antenna group providing the UCI to the second antenna group and the second antenna group transmitting the UCI, the UCI may have increased reliability (e.g., based at least in part on the second antenna group having components and/or capability to transmit the UCI to the base station), which may conserve processing, power, communication, and network resources that may have otherwise been consumed to detect and/or correct a failure of a base station to receive the UCI.

FIG. 3 is a diagram illustrating an example 300 associated with uplink control information cooperation, in accordance with the present disclosure. As shown in FIG. 3, a UE (e.g., UE 120) may communicate with a base station (e.g., base station 110) via a first antenna group and/or a second antenna group. In some aspects, the UE may include the first antenna group and the second antenna group. In some aspects, a cooperative UE (e.g., UE 120) may include the second antenna group. The cooperative UE may communicate with the UE and/or the base station via the second antenna group. The UE, the base station, and/or the cooperative UE may be part of a wireless network (e.g., wireless network 100). In some aspects, the UE and the cooperative UE may communicate via a sidelink channel and/or a direct link.

As shown by reference number 305, the base station may transmit, and the first antenna group of the UE may receive, configuration information. In some aspects, the first antenna group of the UE may receive configuration information from another device (e.g., from another base station, a TRP associated with the base station, and/or another UE, among other examples) and/or a communication standard, among other examples. In some aspects, the first antenna group of the UE may receive the configuration information via one or more of radio resource control (RRC) signaling or medium access control control element (MAC-CE) signaling, and/or the first antenna group of the UE may determine the configuration information from a communication standard, among other examples. In some aspects, the configuration information may include an indication of one or more configuration parameters (e.g., already known to the UE) for selection by the UE, explicit configuration information for the UE to use to configure the UE, and/or the like.

In some aspects, the configuration information may indicate that the UE is to transmit UCI based at least in part on receiving a data communication. In some aspects, the configuration information may enable UCI cooperation in which the UE may provide the UCI to the second antenna group for transmission to the base station. In some aspects, the configuration information may indicate that the cooperative UE is configured as a cooperative device for transmitting the UCI.

In some aspects, the UE may configure the UE and/or the first antenna group for communicating with the base station. In some aspects, the UE may configure the UE and/or the first antenna group based at least in part on the configuration information. In some aspects, the UE may be configured to perform one or more operations described herein.

As shown by reference number 310, the base station may transmit, and the second antenna group (e.g., of the UE or of a cooperative UE) may receive, configuration information. In some aspects, the second antenna group may receive configuration information from another device (e.g., from another base station, a TRP associated with the base station, the UE, and/or another UE, among other examples) and/or a communication standard, among other examples. In some aspects, the second antenna group may receive the configuration information via one or more of RRC signaling or MAC-CE signaling, and/or the UE or the cooperative UE may determine the configuration information from a communication standard, among other examples. In some aspects, the configuration information may include an indication of one or more configuration parameters (e.g., already known to the UE or the cooperative UE) for selection by the UE or the cooperative UE, explicit configuration information for the UE or the cooperative UE to use to configure the UE or the cooperative UE, and/or the like.

In some aspects, the configuration information may indicate that the second antenna group is to transmit UCI associated with the first antenna group. In some aspects, the configuration information may enable UCI cooperation in which the second antenna group may receive the UCI from the UE for transmission to the base station. In some aspects, the configuration information may indicate that the second antenna group is to transmit UCI associated with the first antenna group and UCI associated with the second antenna group. In some aspects, the configuration information may indicate that the cooperative UE is configured as a cooperative device for transmitting the UCI.

In some aspects, the UE or the cooperative UE may configure the second antenna group for communicating with the base station. In some aspects, the UE or the cooperative UE may configure the second antenna group based at least in part on the configuration information. In some aspects, the cooperative UE may be configured to perform one or more operations described herein.

As shown by reference number 315, the second antenna group may receive an indication of a configuration for transmission of UCI and/or a configuration for a PUCCH resource. In some aspects, the second antenna group may receive the configuration of the UCI and/or the configuration for the PUCCH resource via DCI (e.g., DCI that schedules an associated data communication). In some aspects, the second antenna group may receive the configuration of the UCI and/or the configuration for the PUCCH resource via another device (e.g., indirectly from the base station), such as the first antenna group and/or the UE.

In some aspects, the second antenna group (e.g., the UE or the cooperative UE that includes the second antenna group) may receive a configuration of a PUCCH resource configured for the UE that indicates that the second antenna group is to transmit the UCI associated with the UE. In some aspects, the second antenna group is included in the cooperative UE and the configuration of the PUCCH resource may indicate that the cooperative UE is to transmit the UCI, associated with the UE, via the second antenna group. In some aspects, the second antenna group is included in the cooperative UE, and the configuration of the PUCCH resource may indicate that the cooperative UE is to transmit the UCI, associated with the UE, via the second antenna group.

In some aspects, the PUCCH resource may be configured for the first antenna group or for the second antenna group. In some aspects, the PUCCH resource may be configured for the UE or for the cooperative UE. In some aspects, the configuration of the PUCCH resource may include an indication of an identification of the cooperative UE or the second antenna group, an indication of a resource timing that is based at least in part on a numerology of the cooperative UE or the second antenna group, and/or an indication of a secondary PUCCH cell group as a supplementary PUCCH for transmission of the UCI associated with the UE.

As shown by reference number 320, the first antenna group may receive an indication of a configuration for transmission of UCI associated with the first antenna group and/or a configuration for a PUCCH resource. In some aspects, the first antenna group may receive the configuration of the UCI and/or the configuration for the PUCCH resource via DCI (e.g., DCI that schedules an associated data communication).

In some aspects, the configuration for transmission of the UCI may include an indication that the UCI associated with the first antenna group of the UE is to be transmitted via the second antenna group. In some aspects, the configuration of the PUCCH resource may include an indication of an identification of the second antenna group, an indication of a resource timing that is based at least in part on a numerology of the second antenna group, and/or an indication of a secondary PUCCH cell group as a supplementary PUCCH for transmission of the UCI associated with the first antenna group.

As shown by reference number 325, the first antenna group may provide, and the second antenna group may receive, the UCI associated with the first antenna group. In some aspects in which the second antenna group is included in a cooperative UE, the first antenna group may provide the UCI based at least in part on transmitting the UCI, associated with the first antenna group for transmission to the base station, to the cooperative UE.

As shown by reference number 330, the second antenna group may transmit, and the base station may receive, the UCI associated with the first antenna group and/or additional UCI. In some aspects, the second antenna group may transmit the UCI via a PUCCH resource configured for the first antenna group or via a PUCCH resource configured for the second antenna group. In some aspects, the PUCCH resource configured for the first antenna group may indicate (e.g., via a spatial relation indication and/or an identification of the cooperative UE) that the second antenna group is to transmit the UCI associated with the first antenna group.

In some aspects, the second antenna group may transmit a PUCCH communication that includes the UCI associated with the first antenna group of the UE and additional UCI associated with the second antenna group of the UE. In some aspects, the UCI associated with the first antenna group may be associated with a data communication received via the first antenna group and/or the additional UCI may be associated with a data communication received via the second antenna group. In some aspects, the PUCCH communication may include a first UCI group (e.g., an indication of first UCI) associated with the first antenna group and a second UCI group (e.g., an indication of second UCI) associated with the second antenna group. For example, the PUCCH communication may use a first HARQ codebook associated with the first antenna group and a second HARQ codebook associated with the second antenna group. Alternatively, the PUCCH communication may include a single UCI group based at least in part on a single HARQ codebook configured for both of the first antenna group and the second antenna group. In other words, an indication using the single HARQ codebook may indicate the UCI and the additional UCI.

In some aspects, the second antenna group may transmit the PUCCH communication using a PUCCH format that is different from a PUCCH format used by the first antenna group to provide the UCI. For example, the first antenna group may use a PUCCH format 0 or format 1 to provide the UCI (e.g., based at least in part on a configuration for the transmission of the UCI). The second antenna group may use a PUCCH format 3 or format 4 (e.g., a format with a payload sufficient to include multiple UCI indications).

In some aspects in which the second antenna group includes a second antenna group of the UE, the UE may transmit the UCI associated with the first antenna group via the second antenna group.

As shown by reference number 335, the first antenna group may transmit the UCI associate with the first antenna group. In some aspects, the first antenna group may transmit a repetition of the UCI along with transmission via the second antenna group. In this way, the base station may have an improved likelihood of receiving the UCI.

Based at least in part on the first antenna group providing the UCI to the second antenna group and the second antenna group transmitting the UCI with additional UCI, the UE and/or the cooperative UE may conserve power, communication, and/or network resources that may have otherwise been used to transmit the UCI separately from the additional UCI. Based at least in part on the first antenna group providing the UCI to the second antenna group and the second antenna group transmitting the UCI, the UCI may have increased reliability (e.g., based at least in part on the second antenna group having components and/or capability to transmit the UCI to the base station), which may conserve processing, power, communication, and network resources that may have otherwise been consumed to detect and/or correct a failure of a base station to receive the UCI.

As indicated above, FIG. 3 is provided as an example. Other examples may differ from what is described with regard to FIG. 3.

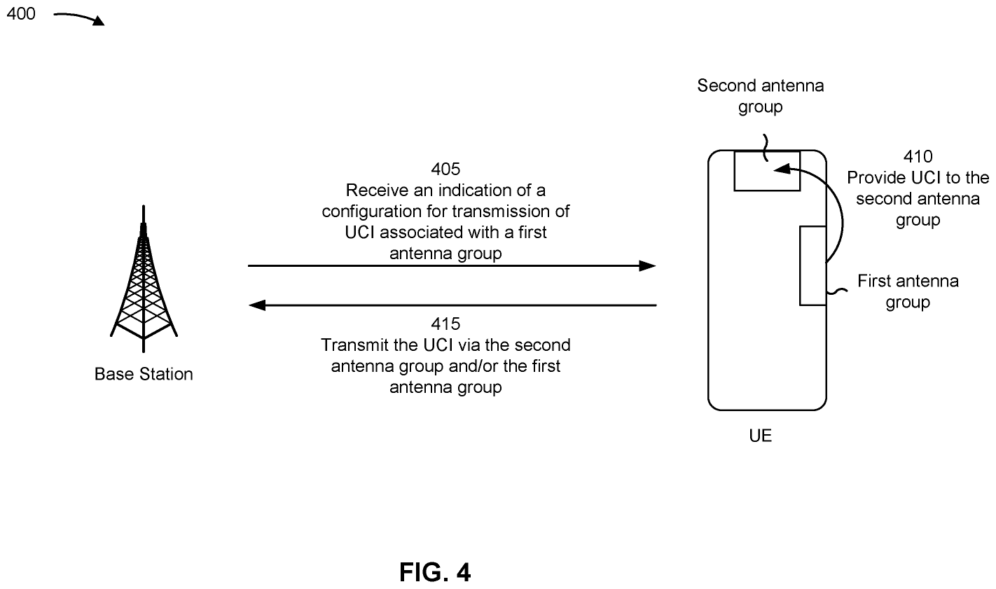

FIG. 4 is a diagram illustrating an example 400 associated with uplink control information cooperation, in accordance with the present disclosure. As shown in FIG. 4, a UE (e.g., UE 120) may communicate with a base station (e.g., base station 110) via a first antenna group and/or a second antenna group. The UE and the base station may be part of a wireless network (e.g., wireless network 100).

As shown by reference number 405, the UE may receive an indication of a configuration for transmission of UCI associated with the first antenna group. For example, the UE may receive the configuration via DCI that schedules an associated data communication. The configuration may indicate that the UE is to provide UCI, associated with the first antenna group, to the second antenna group for transmission to the base station. As shown by reference number 410, the UE may provide the UCI to the second antenna group.

As shown by reference number 415, the UE may transmit the UCI via the second antenna group. In some aspects, the UE may also transmit the UCI via the first antenna group (e.g., a repetition of the UCI). In some aspects, the UE may transmit additional UCI associated with the second antenna group along with the UCI, as described herein.

As indicated above, FIG. 4 is provided as an example. Other examples may differ from what is described with regard to FIG. 4.

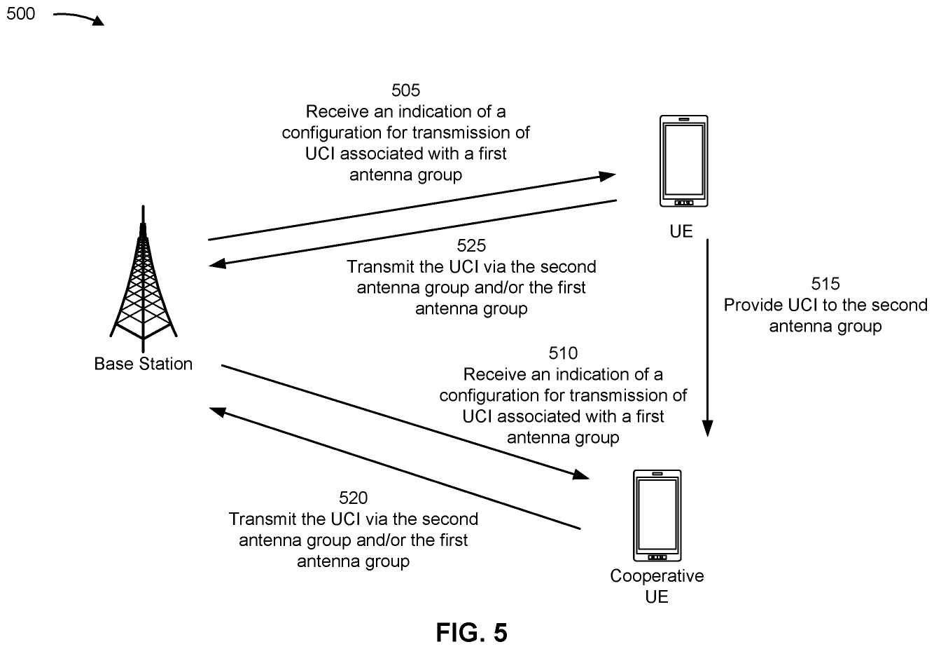

FIG. 5 is a diagram illustrating an example 500 associated with uplink control information cooperation, in accordance with the present disclosure. As shown in FIG. 5, a UE (e.g., UE 120) may communicate with a base station (e.g., base station 110) via a first antenna group. In some aspects, a cooperative UE (e.g., UE 120) may include a second antenna group. The cooperative UE may communicate with the UE and/or the base station via the second antenna group. The UE, the base station, and/or the cooperative UE may be part of a wireless network (e.g., wireless network 100). In some aspects, the UE and the cooperative UE may communicate via a sidelink channel and/or a direct link.

As shown by reference number 505, the UE may receive an indication of a configuration for transmission of UCI associated with the first antenna group. For example, the UE may receive the configuration via DCI that schedules an associated data communication. The configuration may indicate that the UE is to provide UCI, associated with the first antenna group, to the cooperative UE for transmission to the base station via the second antenna group.

As shown by reference number 510, the cooperative UE may receive an indication of a configuration for transmission of UCI associated with the first antenna group. The configuration may indicate that the cooperative UE is to transmit the UCI, associated with the first antenna group, to the base station via the second antenna group. In some aspects, the configuration may indicate a PUCCH format to use for transmission of the UCI and/or whether the cooperative UE is to transmit additional UCI associated with the second antenna group along with the UCI associated with the first antenna group. In some aspects, the configuration may indicate a codebook for transmission of a PUCCH communication that indicates the UCI and/or additional UCI.

As shown by reference number 515, the UE may provide the UCI to the second antenna group. For example, the UE may provide the UCI to the cooperative UE via the second antenna group, via a wireless link that does not include the second antenna group, and/or via a local area network link, among other examples.

As shown by reference number 520, the cooperative UE may transmit the UCI via the second antenna group. In some aspects, the cooperative UE may transmit the UCI along with additional UCI in a PUCCH communication, as described herein. As shown by reference number 525, the UE may also transmit the UCI via the first antenna group (e.g., a repetition of the UCI).

As indicated above, FIG. 5 is provided as an example. Other examples may differ from what is described with regard to FIG. 5.

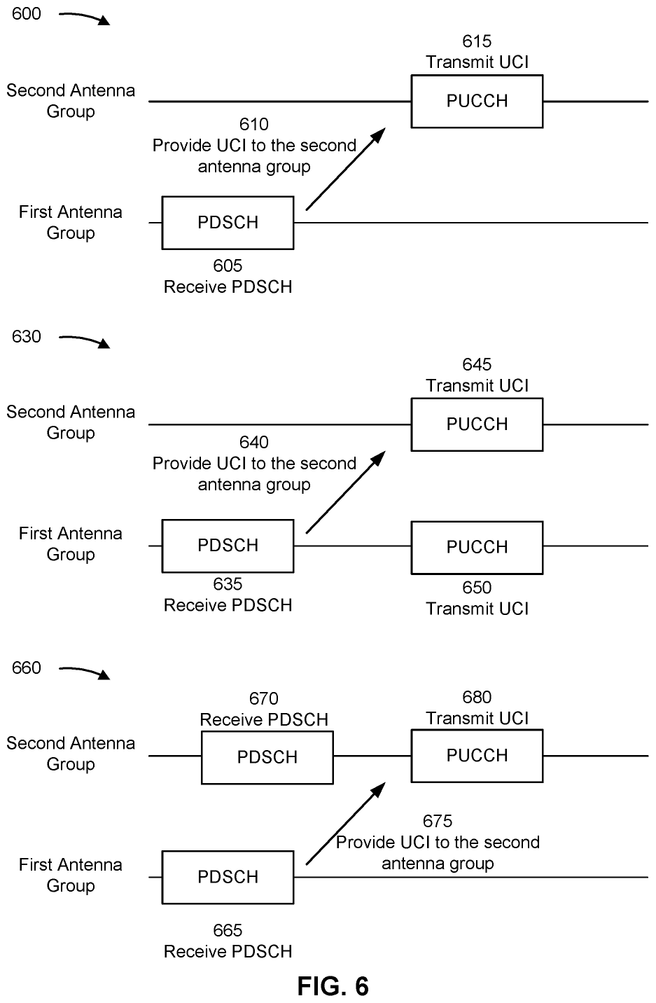

FIG. 6 is a diagram illustrating examples associated with uplink control information cooperation, in accordance with the present disclosure. As shown in FIG. 6, a UE (e.g., UE 120) may communicate with a base station (e.g., base station 110) via a first antenna group and/or a second antenna group. In some aspects, the UE may include the first antenna group and the second antenna group. In some aspects, a cooperative UE (e.g., UE 120) may include the second antenna group. The cooperative UE may communicate with the UE and/or the base station via the second antenna group. The UE, the base station, and/or the cooperative UE may be part of a wireless network (e.g., wireless network 100). In some aspects, the UE and the cooperative UE may communicate via a sidelink channel and/or a direct link.

FIG. 6 illustrates example 600 associated with UCI cooperation. As shown by reference number 605, the first antenna group may receive a PDSCH communication. As shown by reference number 610, the first antenna group may provide UCI, associated with the PDSCH communication, to the second antenna group. As shown by reference number 615, the second antenna group may transmit the UCI via a PUCCH communication.

In some aspects, the second antenna group may transmit the UCI in a dedicated PUCCH resource originally configured for the first antenna group. For example, a PUCCH resource indicator may be based at least in part on the first antenna group. In some aspects, resource timing may be based at least in part on a numerology of the first antenna group. In some aspects, a configuration of the PUCCH resource may indicate power control parameters, such as a pathloss reference signal, P0, a closed loop index, and/or beam indications may be associated with transmission via the second antenna group. In some aspects, the dedicated PUCCH resource may indicate that the second antenna group is to transmit a PUCCH communication, including the UCI associated with the first antenna group, using a PUCCH format (e.g., format 3 or format 4). In some aspects, the dedicated PUCCH resource may indicate a PUCCH format for the second antenna group that is different from a PUCCH format configured for the first antenna group.

In some aspects, the PUCCH resource may indicate a PUCCH cell group, for transmission of the UCI associated with the first antenna group, that is associated with the second antenna group. In some aspects, the second antenna group may provide a secondary cell group as a supplementary PUCCH for the first antenna group.

In some aspects, the second antenna group may transmit the UCI in a dedicated PUCCH resource originally configured for the second antenna group. For example, a PUCCH resource indicator may be based at least in part on the second antenna group. In some aspects, resource timing may be based at least in part on a numerology of the second antenna group. In some aspects, a configuration of the PUCCH resource may indicate power control parameters, such as a pathloss reference signal, P0, a closed loop index, and/or beam indications may be associated with transmission via the second antenna group.

FIG. 6 also illustrates example 630 associated with UCI cooperation. As shown by reference number 635, the first antenna group may receive a PDSCH communication. As shown by reference number 640, the first antenna group may provide UCI, associated with the PDSCH communication, to the second antenna group. As shown by reference number 645, the second antenna group may transmit the UCI via a PUCCH communication.

As shown by reference number 650, the first antenna group may transmit the UCI via a PUCCH communication. For example, the first antenna group and the second antenna group may transmit repetitions of the UCI, which may improve reliability of the UCI. In some aspects, a dedicated PUCCH may be configured with two uplink transmission configuration (TCI) states and/or spatial relations (e.g., spatial transmit filters). A first uplink TCI state or spatial relation may be associated with the first antenna group and a second uplink TCI state or spatial relation may be associated with the second antenna group. The uplink TCI states may be indicated with a TCI state applicable only to the dedicated PUCCH, or may be indicated with a TCI state applicable to multiple channels including the dedicated PUCCH. In some aspects, the second antenna group may transmit the UCI using resources allocated to the first antenna group via a configuration of transmission of the UCI and/or a configuration of a PUCCH resource associated with the UCI.

FIG. 6 further illustrates example 660 associated with UCI cooperation. As shown by reference number 665, the first antenna group may receive a PDSCH communication. As shown by reference number 670, the second antenna group may receive an additional PDSCH communication. As shown by reference number 675, the first antenna group may provide UCI, associated with the PDSCH communication received by the first antenna group, to the second antenna group. As shown by reference number 680, the second antenna group may transmit the UCI associated with the first antenna group and additional UCI associated with the first antenna group. In some aspects, the second antenna group may transmit the UCI and the additional UCI via a PUCCH communication.

In some aspects, the second antenna group may transmit the UCI using a PUCCH communication that includes a first UCI group and a second UCI group. The first UCI group may be associated with the first antenna group (e.g., the PDSCH received via the first antenna group). The second UCI group may be associated with the second antenna group (e.g., the PDSCH received via the second antenna group). A HARQ codebook associated with the first antenna group may be included in the first UCI group and a HARQ codebook associated with the second antenna group may be included in the second UCI group.

In some aspects, the second antenna group may transmit the UCI using a PUCCH communication that includes a single UCI group. The single UCI group may be used for both of the UCI, associated with the first antenna group, and the additional UCI, associated with the second antenna group. A single HARQ codebook may be associated with the UCI and the second UCI. In some aspects, the cooperative UE and the UE may share (e.g., have a common) a counter downlink assignment index (C-DAI) and/or a total downlink assignment index (T-DAI) counter. The single HARQ codebook may be ordered based at least in part on a downlink assignment index (DAI) counter in DCI (e.g., DCI that schedules the PDSCH received via the first antenna group and DCI that schedules the PDSCH received via the second antenna group).

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the ULE (e.g., UE 120) performs operations associated with uplink control information cooperation.

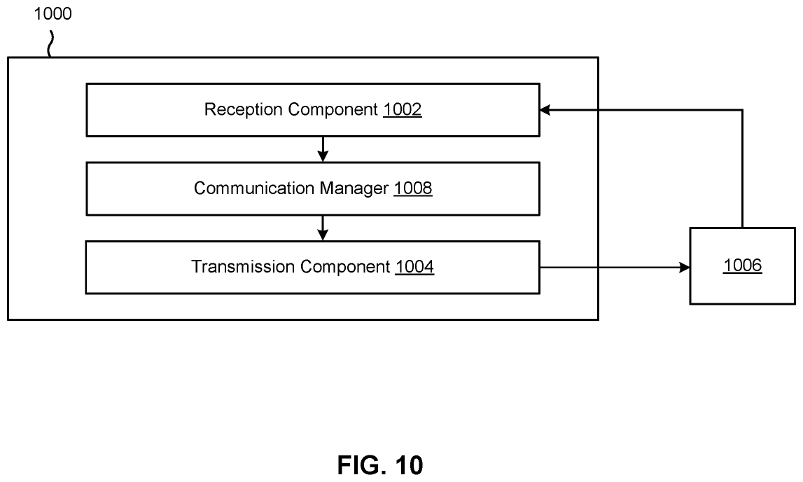

As shown in FIG. 7, in some aspects, process 700 may include receiving, from a base station, an indication of a configuration for transmission of UCI associated with a first antenna group of the UE (block 710). For example, the UE (e.g., using reception component 1002, depicted in FIG. 10) may receive, from a base station, an indication of a configuration for transmission of UCI associated with a first antenna group of the UE, as described above.

As further shown in FIG. 7, in some aspects, process 700 may include providing, to a second antenna group, the UCI associated with the first antenna group of the UE for transmission to the base station (block 720). For example, the UE (e.g., using transmission component 1004, depicted in FIG. 10) may provide, to a second antenna group, the UCI associated with the first antenna group of the UE for transmission to the base station, as described above.

Process 700 may include additional aspects, such as any single aspect or any combination of aspects described below and/or in connection with one or more other processes described elsewhere herein.

In a first aspect, the second antenna group comprises a second antenna group of the UE.

In a second aspect, alone or in combination with the first aspect, process 700 includes transmitting, via the second antenna group of the UE, the UCI associated with the first antenna group.

In a third aspect, alone or in combination with one or more of the first and second aspects, transmitting, via the second antenna group of the UE, the UCI associated with the first antenna group comprises transmitting the UCI associated with the first antenna group via a PUCCH resource configured for the first antenna group, or transmitting the UCI associated with the first antenna group via a PUCCH resource configured for the second antenna group.

In a fourth aspect, alone or in combination with one or more of the first through third aspects, process 700 includes transmitting, via the second antenna group, a PUCCH communication that includes the UCI associated with the first antenna group of the UE and additional UCI associated with the second antenna group of the UE.

In a fifth aspect, alone or in combination with one or more of the first through fourth aspects, transmitting the PUCCH communication comprises transmitting the PUCCH communication including a first UCI group associated with the first antenna group and a second UCI group associated with the second antenna group, or transmitting the PUCCH communication including a single UCI group based at least in part on a single HARQ codebook configured for the first antenna group and the second antenna group.

In a sixth aspect, alone or in combination with one or more of the first through fifth aspects, the PUCCH communication comprises a PUCCH format 3 communication or a PUCCH format 4 communication.

In a seventh aspect, alone or in combination with one or more of the first through sixth aspects, the configuration for transmission of the UCI associated with the first antenna group of the UE includes one or more of an indication of an identification of the second antenna group, an indication of a resource timing that is based at least in part on a numerology of the second antenna group, or an indication of a secondary PUCCH cell group, associated with the second antenna group, as a supplementary PUCCH for transmission of the UCI associated with the first antenna group.

In an eighth aspect, alone or in combination with one or more of the first through seventh aspects, the second antenna group is associated with a cooperative UE, and wherein providing, to the second antenna group, the UCI associated with the first antenna group of the UE for transmission to the base station comprises transmitting, to the cooperative UE, the UCI associated with the first antenna group for transmission to the base station.

In a ninth aspect, alone or in combination with one or more of the first through eighth aspects, process 700 includes transmitting a repetition of the UCI via the first antenna group of the UE.

In a tenth aspect, alone or in combination with one or more of the first through ninth aspects, the configuration for transmission of the UCI comprises an indication that the UCI associated with the first antenna group of the UE is to be transmitted via the second antenna group.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a cooperative UE, in accordance with the present disclosure. Example process 800 is an example where the UE (e.g., UE 120) performs operations associated with uplink control information cooperation.

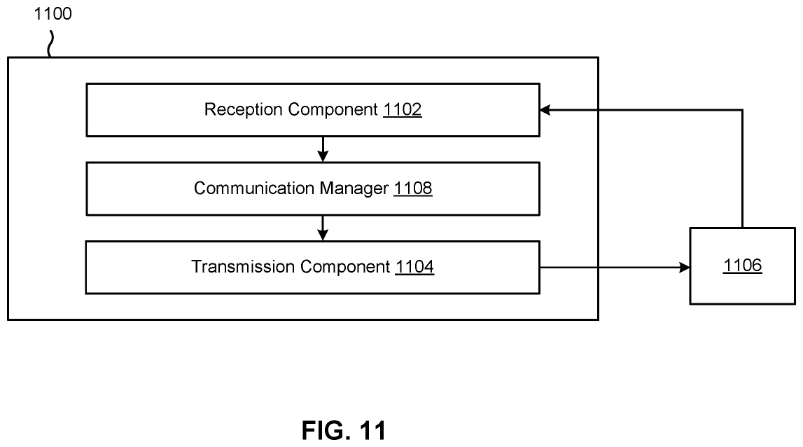

As shown in FIG. 8, in some aspects, process 800 may include receiving, from a UE, UCI associated with the UE (block 810). For example, the UE (e.g., using reception component 1102, depicted in FIG. 11) may receive, from a UE, UCI associated with the UE, as described above.

As further shown in FIG. 8, in some aspects, process 800 may include transmitting, to a base station, the UCI associated with the UE (block 820). For example, the UE (e.g., using transmission component 1104, depicted in FIG. 11) may transmit, to a base station, the UCI associated with the UE, as described above.

Process 800 may include additional aspects, such as any single aspect or any combination of aspects described below and/or in connection with one or more other processes described elsewhere herein.

In a first aspect, process 800 includes transmitting a PUCCH communication that includes the UCI associated with the UE and additional UCI associated with the cooperative UE.

In a second aspect, alone or in combination with the first aspect, the PUCCH communication comprises a first UCI group associated with the UE and a second UCI group associated with the cooperative UE, or a single UCI group based at least in part on a single HARQ codebook configured for the UCI associated with the UE and the additional UE associated with the cooperative UE.

In a third aspect, alone or in combination with one or more of the first and second aspects, the PUCCH communication comprises a PUCCH format 3 communication or a PUCCH format 4 communication.

In a fourth aspect, alone or in combination with one or more of the first through third aspects, receiving, from the UE, the UCI associated with the UE comprises receiving the UCI in a first PUCCH format, and wherein transmitting the PUCCH communication that includes the UCI associated with the UE and the additional UCI associated with the cooperative UE comprises transmitting the PUCCH communication in a second PUCCH format that is different from the first PUCCH format.

In a fifth aspect, alone or in combination with one or more of the first through fourth aspects, transmitting, to the base station, the UCI associated with the UE comprises transmitting the UCI associated with the UE via a PUCCH resource configured for the UE, or transmitting the UCI associated with the UE via a PUCCH resource configured for the cooperative UE.

In a sixth aspect, alone or in combination with one or more of the first through fifth aspects, a configuration of the PUCCH resource configured for the UE indicates that the cooperative UE is to transmit the UCI associated with the UE.

In a seventh aspect, alone or in combination with one or more of the first through sixth aspects, process 800 includes receiving a configuration of a PUCCH resource configured for the cooperative UE, wherein the configuration of the PUCCH resource configured for the cooperative UE includes one or more of an indication of an identification of the cooperative UE, an indication of a resource timing that is based at least in part on a numerology of the cooperative UE, or an indication of a secondary PUCCH cell group as a supplementary PUCCH for transmission of the UCI associated with the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with uplink control information cooperation.

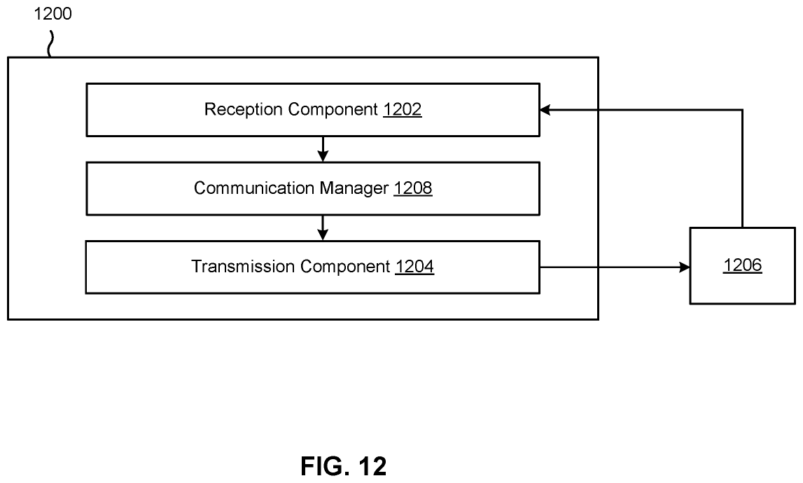

As shown in FIG. 9, in some aspects, process 900 may include transmitting, to a first antenna group of a UE, an indication of a configuration for transmission of UCI associated with a first antenna group of the UE (block 910). For example, the base station (e.g., using transmission component 1204, depicted in FIG. 12) may transmit, to a first antenna group of a UE, an indication of a configuration for transmission of UCI associated with a first antenna group of the UE, as described above.

As further shown in FIG. 9, in some aspects, process 900 may include receiving, via a second antenna group, the UCI associated with the first antenna group (block 920). For example, the base station (e.g., using reception component 1202, depicted in FIG. 12) may receive, via a second antenna group, the UCI associated with the first antenna group, as described above.

Process 900 may include additional aspects, such as any single aspect or any combination of aspects described below and/or in connection with one or more other processes described elsewhere herein.

In a first aspect, the second antenna group comprises a second antenna group of the UE, or wherein the second antenna group is associated with a cooperative UE.

In a second aspect, alone or in combination with the first aspect, receiving, via the second antenna group, the UCI associated with the first antenna group comprises receiving the UCI associated with the first antenna group via a PUCCH resource configured for the first antenna group, or receiving the UCI associated with the first antenna group via a PUCCH resource configured for the second antenna group.

In a third aspect, alone or in combination with one or more of the first and second aspects, receiving, via the second antenna group, the UCI associated with the first antenna group comprises receiving, via the second antenna group, a PUCCH communication that includes the UCI associated with the first antenna group and additional UCI associated with the second antenna group.

In a fourth aspect, alone or in combination with one or more of the first through third aspects, receiving, via the second antenna group, the UCI associated with the first antenna group comprises receiving a PUCCH communication including a first UCI group associated with the first antenna group and a second UCI group associated with the second antenna group, or receiving the PUCCH communication including a single UCI group based at least in part on a single HARQ codebook configured for the first antenna group and the second antenna group.

In a fifth aspect, alone or in combination with one or more of the first through fourth aspects, receiving, via the second antenna group, the UCI associated with the first antenna group comprises receiving the UCI associated with the first antenna group via a PUCCH format 3 communication or a PUCCH format 4 communication.

In a sixth aspect, alone or in combination with one or more of the first through fifth aspects, the indication of the configuration for transmission of the UCI associated with a first antenna group of the UE comprises an indication of an identification of the second antenna group, an indication of a resource timing that is based at least in part on a numerology of the second antenna group, or an indication of a secondary PUCCH cell group, associated with the second antenna group, as a supplementary PUCCH for transmission of the UCI associated with the first antenna group.

In a seventh aspect, alone or in combination with one or more of the first through sixth aspects, process 900 includes receiving a repetition of the UCI via the first antenna group of the UE.

In an eighth aspect, alone or in combination with one or more of the first through seventh aspects, the configuration for transmission of the UCI comprises an indication that the UCI associated with the first antenna group of the UE is to be transmitted via the second antenna group.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include one or more of a communication manager 1008.

In some aspects, the apparatus 1000 may be configured to perform one or more operations described herein in connection with FIGS. 3-6. Additionally, or alternatively, the apparatus 1000 may be configured to perform one or more processes described herein, such as process 700 of FIG. 7. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The reception component 1002 may receive, from a base station, an indication of a configuration for transmission of UCI associated with a first antenna group of the UE. The transmission component 1004 may provide, to a second antenna group, the UCI associated with the first antenna group of the UE for transmission to the base station.

The transmission component 1004 may transmit, via the second antenna group of the UE, the UCI associated with the first antenna group.

The transmission component 1004 may transmit, via the second antenna group, a PUCCH communication that includes the UCI associated with the first antenna group of the UE and additional UCI associated with the second antenna group of the UE.

The transmission component 1004 may transmit a repetition of the UCI via the first antenna group of the UE.

The communication manager 1008 may manage communications with the apparatus 1206.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a cooperative UE, or a cooperative UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108.

In some aspects, the apparatus 1100 may be configured to perform one or more operations described herein in connection with FIGS. 3-6. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the cooperative UE described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a demodulator, a MIMO detector, a receive processor, a controller/processor, a memory, or a combination thereof, of the cooperative UE described above in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the cooperative UE described above in connection with FIG. 2. In some aspects, the transmission component 1104 may be co-located with the reception component 1102 in a transceiver.

The reception component 1102 may receive, from a UE, UCI associated with the UE. The transmission component 1104 may transmit, to a base station, the UCI associated with the UE.

The transmission component 1104 may transmit a PUCCH communication that includes the UCI associated with the UE and additional UCI associated with the cooperative UE.

The reception component 1102 may receive a configuration of a PUCCH resource configured for the cooperative UE wherein the configuration of the PUCCH resource configured for the cooperative UE includes one or more of: an indication of an identification of the cooperative UE, an indication of a resource timing that is based at least in part on a numerology of the cooperative UE, or an indication of a secondary PUCCH cell group as a supplementary PUCCH for transmission of the UCI associated with the UE.

The communication manager 1108 may manage communications with the apparatus 1106.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a block diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include a communication manager.

In some aspects, the apparatus 1200 may be configured to perform one or more operations described herein in connection with FIGS. 3-6. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the base station described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the base station described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the base station described above in connection with FIG. 2. In some aspects, the transmission component 1204 may be co-located with the reception component 1202 in a transceiver.

The transmission component 1204 may transmit, to a first antenna group of a UE, an indication of a configuration for transmission of UCI associated with a first antenna group of the UE. The reception component 1202 may receive, via a second antenna group, the UCI associated with the first antenna group.

The reception component 1202 may receive a repetition of the UCI via the first antenna group of the UE.

The communication manager 1208 may manage communications with apparatus 1206.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some aspects of the present disclosure:

Aspect 1: A method of wireless communication performed by a user equipment (UE), comprising: receiving, from a base station, an indication of a configuration for transmission of uplink control information (UCI) associated with a first antenna group of the UE; and providing, to a second antenna group, the UCI associated with the first antenna group of the UE for transmission to the base station.

Aspect 2: The method of aspect 1, wherein the second antenna group comprises a second antenna group of the UE.

Aspect 3: The method of aspect 2, further comprising: transmitting, via the second antenna group of the UE, the UCI associated with the first antenna group.

Aspect 4: The method of aspect 3, wherein transmitting, via the second antenna group of the UE, the UCI associated with the first antenna group comprises: transmitting the UCI associated with the first antenna group via a physical uplink control channel (PUCCH) resource configured for the first antenna group, or transmitting the UCI associated with the first antenna group via a PUCCH resource configured for the second antenna group.

Aspect 5: The method of any of aspects 2 through 4, further comprising: transmitting, via the second antenna group, a physical uplink control channel (PUCCH) communication that includes the UCI associated with the first antenna group of the UE and additional UCI associated with the second antenna group of the UE.

Aspect 6: The method of aspect 5, wherein transmitting the PUCCH communication comprises: transmitting the PUCCH communication including a first UCI group associated with the first antenna group and a second UCI group associated with the second antenna group, or transmitting the PUCCH communication including a single UCI group based at least in part on a single hybrid automatic repeat request (HARQ) codebook configured for the first antenna group and the second antenna group.

Aspect 7: The method of any of aspects 5 through 6, wherein the PUCCH communication comprises a PUCCH format 3 communication or a PUCCH format 4 communication.

Aspect 8: The method of any of aspects 1 through 7, wherein the configuration for transmission of the UCI associated with the first antenna group of the UE includes one or more of: an indication of an identification of the second antenna group, an indication of a resource timing that is based at least in part on a numerology of the second antenna group, or an indication of a secondary physical uplink control channel (PUCCH) cell group, associated with the second antenna group, as a supplementary PUCCH for transmission of the UCI associated with the first antenna group.

Aspect 9: The method of aspect 1, wherein the second antenna group is associated with a cooperative UE, and wherein providing, to the second antenna group, the UCI associated with the first antenna group of the UE for transmission to the base station comprises: transmitting, to the cooperative UE, the UCI associated with the first antenna group for transmission to the base station.

Aspect 10: The method of any of aspects 1 through 9, further comprising: transmitting a repetition of the UCI via the first antenna group of the UE.

Aspect 11: The method of any of aspects 1 through 10, wherein the configuration for transmission of the UCI comprises an indication that the UCI associated with the first antenna group of the UE is to be transmitted via the second antenna group.

Aspect 12: A method performed by a cooperative user equipment (UE), comprising: receiving, from a UE, uplink control information (UCI) associated with the UE; and transmitting, to a base station, the UCI associated with the UE.

Aspect 13: The method of aspect 12, further comprising transmitting a physical uplink control channel (PUCCH) communication that includes the UCI associated with the UE and additional UCI associated with the cooperative UE.

Aspect 14: The method of aspect 13, wherein the PUCCH communication comprises: a first UCI group associated with the UE and a second UCI group associated with the cooperative UE, or a single UCI group based at least in part on a single hybrid automatic repeat request (HARQ) codebook configured for the UCI associated with the UE and the additional UE associated with the cooperative UE.

Aspect 15: The method of any of aspects 13 through 14, wherein the PUCCH communication comprises a PUCCH format 3 communication or a PUCCH format 4 communication.

Aspect 16: The method of any of aspects 13 through 15, wherein receiving, from the UE, the UCI associated with the UE comprises receiving the UCI in a first PUCCH format, and wherein transmitting the PUCCH communication that includes the UCI associated with the UE and the additional UCI associated with the cooperative UE comprises transmitting the PUCCH communication in a second PUCCH format that is different from the first PUCCH format.

Aspect 17: The method of any of aspects 13 through 16, wherein transmitting, to the base station, the UCI associated with the UE comprises: transmitting the UCI associated with the UE via a physical uplink control channel (PUCCH) resource configured for the UE, or transmitting the UCI associated with the UE via a PUCCH resource configured for the cooperative UE.

Aspect 18: The method of aspect 17, wherein a configuration of the PUCCH resource configured for the UE indicates that the cooperative UE is to transmit the UCI associated with the UE.

Aspect 19: The method of any of aspects 13 through 18, further comprising: receiving a configuration of a physical uplink control channel (PUCCH) resource configured for the cooperative UE, wherein the configuration of the PUCCH resource configured for the cooperative UE includes one or more of: an indication of an identification of the cooperative UE, an indication of a resource timing that is based at least in part on a numerology of the cooperative UE, or an indication of a secondary PUCCH cell group as a supplementary PUCCH for transmission of the UCI associated with the UE.

Aspect 20: A method performed by a base station, comprising: transmitting, to a first antenna group of a user equipment (UE), an indication of a configuration for transmission of uplink control information (UCI) associated with a first antenna group of the UE; and receiving, via a second antenna group, the UCI associated with the first antenna group.

Aspect 21: The method of aspect 20, wherein the second antenna group comprises a second antenna group of the UE, or wherein the second antenna group is associated with a cooperative UE.

Aspect 22: The method of any of aspects 20 through 21, wherein receiving, via the second antenna group, the UCI associated with the first antenna group comprises: receiving the UCI associated with the first antenna group via a physical uplink control channel (PUCCH) resource configured for the first antenna group, or receiving the UCI associated with the first antenna group via a PUCCH resource configured for the second antenna group.

Aspect 23: The method of any of aspects 20 through 22, wherein receiving, via the second antenna group, the UCI associated with the first antenna group comprises: receiving, via the second antenna group, a physical uplink control channel (PUCCH) communication that includes the UCI associated with the first antenna group and additional UCI associated with the second antenna group.

Aspect 24: The method of any of aspects 20 through 23, wherein receiving, via the second antenna group, the UCI associated with the first antenna group comprises: receiving a physical uplink control channel (PUCCH) communication including a first UCI group associated with the first antenna group and a second UCI group associated with the second antenna group, or receiving the PUCCH communication including a single UCI group based at least in part on a single hybrid automatic repeat request (HARQ) codebook configured for the first antenna group and the second antenna group.

Aspect 25: The method of any of aspects 20 through 24, wherein receiving, via the second antenna group, the UCI associated with the first antenna group comprises: receiving the UCI associated with the first antenna group via a physical uplink control channel (PUCCH) format 3 communication or a PUCCH format 4 communication.

Aspect 26: The method of any of aspects 20 through 25, wherein the indication of the configuration for transmission of the UCI associated with a first antenna group of the UE comprises: an indication of an identification of the second antenna group, an indication of a resource timing that is based at least in part on a numerology of the second antenna group, or an indication of a secondary physical uplink control channel (PUCCH) cell group, associated with the second antenna group, as a supplementary PUCCH for transmission of the UCI associated with the first antenna group.

Aspect 27: The method of any of aspects 20 through 26, further comprising: receiving a repetition of the UCI via the first antenna group of the UE.

Aspect 28: The method of any of aspects 20 through 27, wherein the configuration for transmission of the UCI comprises an indication that the UCI associated with the first antenna group of the UE is to be transmitted via the second antenna group.

Aspect 29: An apparatus for wireless communication at a device, comprising a processor; memory coupled with the processor; and instructions stored in the memory and executable by the processor to cause the apparatus to perform the method of one or more aspects of aspects 1-28.

Aspect 30: A device for wireless communication, comprising a memory and one or more processors coupled to the memory, the memory and the one or more processors configured to perform the method of one or more aspects of aspects 1-28.

Aspect 31: An apparatus for wireless communication, comprising at least one means for performing the method of one or more aspects of aspects 1-28.

Aspect 32: A non-transitory computer-readable medium storing code for wireless communication, the code comprising instructions executable by a processor to perform the method of one or more aspects of aspects 1-28.

Aspect 33: A non-transitory computer-readable medium storing a set of instructions for wireless communication, the set of instructions comprising one or more instructions that, when executed by one or more processors of a device, cause the device to perform the method of one or more aspects of aspects 1-28.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors operatively coupled to the memory, the memory and the one or more processors configured to:
receive, from a base station, an indication of a configuration for transmission of uplink control information (UCI) associated with a first antenna group of the UE; and
provide, to a second antenna group, the UCI associated with the first antenna group of the UE for transmission to the base station.

2. The UE of claim 1, wherein the second antenna group comprises a second antenna group of the UE.

3. The UE of claim 2, wherein the one or more processors are further configured to:
transmit, via the second antenna group of the UE, the UCI associated with the first antenna group.

4. The UE of claim 3, wherein the one or more processors, when transmitting the UCI associated with the first antenna group, are configured to:
transmit the UCI associated with the first antenna group via a physical uplink control channel (PUCCH) resource configured for the first antenna group, or
transmit the UCI associated with the first antenna group via a PUCCH resource configured for the second antenna group.

5. The UE of claim 2, wherein the one or more processors are further configured to:
transmit, via the second antenna group, a physical uplink control channel (PUCCH) communication that includes the UCI associated with the first antenna group of the UE and additional UCI associated with the second antenna group of the UE.

6. The UE of claim 5, wherein the one or more processors, when transmitting the PUCCH communication, are configured to:
transmit the PUCCH communication including a first UCI group associated with the first antenna group and a second UCI group associated with the second antenna group, or
transmit the PUCCH communication including a single UCI group based at least in part on a single hybrid automatic repeat request (HARQ) codebook configured for the first antenna group and the second antenna group.

7. The UE of claim 5, wherein the PUCCH communication comprises a PUCCH format 3 communication or a PUCCH format 4 communication.

8. The UE of claim 1, wherein the configuration for transmission of the UCI associated with the first antenna group of the UE includes one or more of:
an indication of an identification of the second antenna group,
an indication of a resource timing that is based at least in part on a numerology of the second antenna group, or
an indication of a secondary physical uplink control channel (PUCCH) cell group, associated with the second antenna group, as a supplementary PUCCH for transmission of the UCI associated with the first antenna group.

9. The UE of claim 1, wherein the second antenna group is associated with a cooperative UE, and
wherein the one or more processors, when providing the UCI associated with the first antenna group of the UE for transmission to the base station, are configured to:
transmit, to the cooperative UE, the UCI associated with the first antenna group for transmission to the base station.

10. The UE of claim 1, wherein the one or more processors are further configured to:
transmit a repetition of the UCI via the first antenna group of the UE.

11. The UE of claim 1, wherein the configuration for transmission of the UCI comprises an indication that the UCI associated with the first antenna group of the UE is to be transmitted via the second antenna group.

12. A cooperative user equipment (UE) for wireless communication, comprising:
a memory; and
one or more processors operatively coupled to the memory, the memory and the one or more processors configured to:
receive, from a UE, uplink control information (UCI) associated with the UE; and
transmit, to a base station, the UCI associated with the UE.

13. The UE of claim 12, wherein the one or more processors are further configured to transmit a physical uplink control channel (PUCCH) communication that includes the UCI associated with the UE and additional UCI associated with the cooperative UE.

14. The UE of claim 13, wherein the PUCCH communication comprises:
a first UCI group associated with the UE and a second UCI group associated with the cooperative UE, or
a single UCI group based at least in part on a single hybrid automatic repeat request (HARQ) codebook configured for the UCI associated with the UE and the additional UE associated with the cooperative UE.

15. The UE of claim 13, wherein the PUCCH communication comprises a PUCCH format 3 communication or a PUCCH format 4 communication.

16. The UE of claim 13, wherein the one or more processors, when receiving the UCI associated with the UE, are configured to receive the UCI in a first PUCCH format, and
wherein the one or more processors, when transmitting the PUCCH communication, are configured to transmit the PUCCH communication in a second PUCCH format that is different from the first PUCCH format.

17. The UE of claim 12, wherein the one or more processors, when transmitting the UCI associated with the UE, are configured to:
transmit the UCI associated with the UE via a physical uplink control channel (PUCCH) resource configured for the UE, or
transmit the UCI associated with the UE via a PUCCH resource configured for the cooperative UE.

18. The UE of claim 17, wherein a configuration of the PUCCH resource configured for the UE indicates that the cooperative UE is to transmit the UCI associated with the UE.

19. The UE of claim 12, wherein the one or more processors are further configured to:
receive a configuration of a physical uplink control channel (PUCCH) resource configured for the cooperative UE,
wherein the configuration of the PUCCH resource configured for the cooperative UE includes one or more of:
an indication of an identification of the cooperative UE,
an indication of a resource timing that is based at least in part on a numerology of the cooperative UE, or
an indication of a secondary PUCCH cell group as a supplementary PUCCH for transmission of the UCI associated with the UE.

20. A base station for wireless communication, comprising:
a memory; and
one or more processors operatively coupled to the memory, the memory and the one or more processors configured to:
transmit, to a first antenna group of a user equipment (UE), an indication of a configuration for transmission of uplink control information (UCI) associated with a first antenna group of the UE; and
receive, via a second antenna group, the UCI associated with the first antenna group.

21. The base station of claim 20, wherein the second antenna group comprises a second antenna group of the UE, or
wherein the second antenna group is associated with a cooperative UE.

22. The base station of claim 20, wherein the one or more processors, when receiving the UCI associated with the first antenna group, are configured to:
receive the UCI associated with the first antenna group via a physical uplink control channel (PUCCH) resource configured for the first antenna group, or
receive the UCI associated with the first antenna group via a PUCCH resource configured for the second antenna group.

23. The base station of claim 20, wherein the one or more processors, when receiving the UCI associated with the first antenna group, are configured to:
receive, via the second antenna group, a physical uplink control channel (PUCCH) communication that includes the UCI associated with the first antenna group and additional UCI associated with the second antenna group.

24. The base station of claim 20, wherein the one or more processors, when receiving the UCI associated with the first antenna group, are configured to:
receive a physical uplink control channel (PUCCH) communication including a first UCI group associated with the first antenna group and a second UCI group associated with the second antenna group, or
receive the PUCCH communication including a single UCI group based at least in part on a single hybrid automatic repeat request (HARQ) codebook configured for the first antenna group and the second antenna group.

25. The base station of claim 20, wherein the one or more processors, when receiving the UCI associated with the first antenna group, are configured to:
receive the UCI associated with the first antenna group via a physical uplink control channel (PUCCH) format 3 communication or a PUCCH format 4 communication.

26. The base station of claim 20, wherein the indication of the configuration for transmission of the UCI associated with a first antenna group of the UE comprises:
an indication of an identification of the second antenna group,
an indication of a resource timing that is based at least in part on a numerology of the second antenna group, or
an indication of a secondary physical uplink control channel (PUCCH) cell group, associated with the second antenna group, as a supplementary PUCCH for transmission of the UCI associated with the first antenna group.

27. The base station of claim 20, wherein the one or more processors are further configured to:
receive a repetition of the UCI via the first antenna group of the UE.

28. The base station of claim 20, wherein the configuration for transmission of the UCI comprises an indication that the UCI associated with the first antenna group of the UE is to be transmitted via the second antenna group.

29. A method of wireless communication performed by a user equipment (UE), comprising:
receiving, from a base station, an indication of a configuration for transmission of uplink control information (UCI) associated with a first antenna group of the UE; and
providing, to a second antenna group, the UCI associated with the first antenna group of the UE for transmission to the base station.

30. The method of claim 29, further comprising:
transmitting, via the second antenna group, a physical uplink control channel (PUCCH) communication that includes the UCI associated with the first antenna group of the UE and additional UCI associated with the second antenna group.
